(19) United States
(12) Patent Application Publication
(10) Pub. No.: US 2026/0184487 A1
(43) Pub. Date: Jul. 2, 2026

(54) THERMOSTABLE SYSTEM FOR HOT GOODS AND PREPARATION THEREOF

(71) Applicants: Council of Scientific and Industrial Research, New Delhi (IN); Createcomm Tech Private Limited, Gurugram, Haryana (IN)

(72) Inventors: Rajeshwar Matche, Kamataka (IN); Sachin R. Chaudhri, Kamataka (IN); Samiran Sengupta, Haryana (IN); Suraj P., Kerala (IN); Thillai Natarajan M, Tamil Nadu (IN)

(73) Assignees: Council of Scientific and Industrial Research, New Delhi (IN); Creatcomm Tech Private Limited, Gurugram, Haryana (IN)

(21) Appl. No.: 19/129,900

(22) PCT Filed: Nov. 16, 2023
(86) PCT No.: PCT/IN2023/051062

§ 371 Date: May 14, 2025

(30) Foreign Application Priority Data
Nov. 16, 2022 (IN) 202211065792

(51) Int. Cl. B65D 81/34; B65D 25/24; B65D 65/46; B65D 81/38

(52) U.S. Cl. CPC B65D 81/3484; B65D 81/3823; B65D 25/24; B65D 65/466

(57) ABSTRACT

The present invention discloses a thermostable system 100 for storage and transportation of hot goods, especially of food items. The said system combines an insulation container 102 made of biodegradable polyurethane with a novel phase change material to provide improved holding time and temperature ranges. With the thermostable system set-forth by the present invention, 10-14 hours of holding time in the range of 45-70° C. was achieved.

This application claims the benefit of Indian Provisional Patent Application 202211065792 filed on Nov. 16, 2022, the entire content of which is hereby incorporated by reference.

### TECHNICAL FIELD OF THE INVENTION

The present invention relates generally to supply chain network, and particularly, but not exclusively, to supply chain network for storage and/or shipping of hot goods such as perishable food products.

### BACKGROUND

The demand for food delivery services and platforms skyrocketed since the pandemic hit the globe over two years ago. Now, 68% of 1,000 consumers surveyed by the National Restaurant Association say they're more likely to purchase takeout or delivery than they were before the pandemic. And to a customer, there's almost nothing worse than paying for a delicious meal for takeaway or delivery, only for it to arrive cold. In a food delivery survey report from First Orion, 36% of respondents listed “cold food” as one of the most common issues requiring customer service contact. Also, delivering hot food hot is not just a customer satisfaction concern; it's also a food safety issue. The FDA states that hot food should be kept at 140° F. to prevent bacteria growth. If a restaurant is delivering food that falls out of the safe temperature zone, it poses a safety risk to customers.

Perishable food supply chains (PFSCs) are characterized with rising food quality and safety concerns, alarming food wastages and losses, and poor economic sustainability. Other factors like shortage or absence of electricity, poor infrastructure, and poor connectivity etc. cause unexpected delays in delivery and consequent loss of quality or spoilage of the products. To mitigate such issues, thermostable systems came into existence.

There are several strategies that can be used when delivering hot food items to customers. The first and most obvious is better food insulation and thus the packaging plays a key role. It is important to choose the right packaging materials and processes to ensure the freshness and safety of products.

Most of the commercially available thermostable systems use an insulation container in conjunction with heating pouches that help maintain the hot temperature inside the insulation containers. Some of the commercially available insulation containers utilize polystyrene, polyethylene, polyvinyl chloride, polypropylene, or polyethylene terephthalate based insulating material to prepare the thermostable containers. However, these materials pose disposal and recycling limitations and are unsafe to use. Polystyrene foam, for example, is a potential human carcinogen and Polyvinyl chloride contains potentially harmful chemical additions such as phthalates, lead, cadmium, and organotin, which are harmful to human health.

Furthermore, most thermostable containers available in the market are typically employed for cold storage transport and in catering services. They fall short for the long-haul transport of hot perishable foods. To ensure hot food reaches customers effectively, strategies extend beyond enhanced insulation. They encompass specific planning for vehicle features, routing based on geographic areas, and prioritizing deliveries, especially given the limited duration these containers can maintain temperature. Current solutions for hot food storage include lunch boxes and larger catering insulation containers. While these maintain heat for brief periods, the larger variants are not feasible for delivering small-scale orders to customers and are too costly for widespread industrial use. Following FDA guidelines, it's essential to keep food within a temperature range of 45 to 70° C. to prevent bacterial contamination and food spoilage. Poor packaging can lead to bacterial growth in perishable items, rendering them unsafe and inedible.

Thus, in the face of rising demand, it's more important than ever to come up with solutions to offer improved and safer containers for storage and/or shipping of hot goods, especially perishable food products such as cooked food.

### OBJECTS OF THE INVENTION

Some of the objects of the present disclosure, which at least one embodiment herein satisfies are as listed herein below.

The principal object of the present invention is to provide an improved thermostable system for supply chain of hot goods, especially cooked food items.

Another object of the present invention is to offer an improved holding time of hot goods.

Another object of the present invention is to provide a wider range of temperature for storage and/or shipping of hot goods.

Yet another object of the present invention is to provide a sustainable thermostable system that is also cost-effective.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention discloses a thermostable system for supply chain of hot goods, such as cooked food items. The disclosed thermostable system is a combination of a novel phase change material (PCM) containing pouches and insulation technology. A phase change material (PCM) is a substance which releases/absorbs sufficient energy at phase transition to provide useful heat or cooling. The PCM disclosed in the present invention offers up to ten hours of holding time in the temperature range of 45-70° C., which is ideal for preventing microbial growth. The said PCM has latent heat of 100 J/gram, and is prepared by simple melting and mixing of required percentage of catechol in glutaric acid at 110° C., followed by cooling to room temperature to crystalize the mixture. In an exemplary embodiment, a 200 gram of PCM was prepared by melting 40 grams of Catechol in 160 grams of Glutaric Acid in a beaker at 110° C. and mixed thoroughly. The mixture was then allowed to cool and crystalize. The formed crystal was then melted at 80° C. and thereafter heat-sealed in Crafted Polypropylene Pouches (CPP). (The volume of the solution required depends on the weight of the food required for the transportation, the weight to volume ratio should be 5:1). The crafted polypropylene pouches were chosen based on glass transition temperature, holding capacity, and the ability to be effectively sealed. The PCM containing pouches have to be preheated at 80° C. for 6 hours before being used in the proposed thermostable system.

Another key component of the disclosed thermostable system is the insulation container. The material chosen for designing the said container is Polyurethane. Most of the commercially available insulation containers utilize polystyrene, polyethylene, polyvinyl chloride, polypropylene, or polyethylene terephthalate based insulating material to prepare the thermostable containers. However, these materials pose disposal and recycling limitations and are unsafe to use. Polystyrene foam, for example, is a potential human carcinogen and Polyvinyl chloride contains potentially harmful chemical additions such as phthalates, lead, cadmium, and organotin, which are harmful to human health. Thus, due to its several beneficial features as compared to the above-mentioned materials, polyurethane makes a great choice as a material for preparation of thermostable containers. The polyurethane containers are particularly cost-effective in production and maintenance in the food delivery sector. They are also suited for long-distance food transportation due to their lightweight nature. Furthermore, the Polyurethanes are non-toxic to the environment as they break down and do not contain any toxic chemicals which can interfere with endocrine systems.

According to the preferred embodiment, Polyurethane Foam (PUF) is filled between the inner and outer walls of the insulation container, wherein the container walls are made up of Aluminium. Based on the holding-time and temperature-range requirements, the thickness of the said container can be decided. The container designed with 12 mm thickness of insulation material showed a heat transfer rate of 378 kJ offered a holding-time of up to 10 hours, while the container designed with 20 mm thickness of insulation material showed a heat transfer rate of 197.60 kJ for and offered a holding-time of up to 14 hours.

In the preferred embodiment, the insulation container is equipped with a Heater Assembly to heat the container externally, allowing for even and consistent heat distribution throughout the material inside the container. The Heater Assembly comprises a heating plate with Nichrome element and is designed to achieve a surface temperature not more than 95° C.

The insulation container is further equipped with a microcontroller-based temperature sensor coupled with a display screen on the outer surface of its top lid to monitor and display the temperature inside the container. The temperature sensor is connected with the microcontroller unit and the temperature inside the container is displayed on an LCD screen

In an exemplary embodiment, the insulation container is covered with Rexine cloth to enhance the aesthetics and facilitate convenient handling of the container. The Rexine cloth is glued to the aluminium container using 3M Glue.

With the thermostable system set-forth by the present invention, 14 hours of holding time in the range of 45-70° C. was achieved.

The present invention has multiple use cases, such as:
Delivery of cooked food items like curries, rice items etc.;
Storage & delivery of Hot meals for Restaurants, Railway Canteens, Cafeterias, etc.;
Storage utility for travelers, street hawkers, vendors, and all stalls in tourist locations;
Accessible in remote areas with a lack of electricity, best for rural areas and beaches.

### BRIEF DESCRIPTION OF THE DRAWINGS

The drawings described herein are for illustrative purposes only of selected embodiments, and are not intended to limit the scope of the present disclosure. The present invention will hereinafter be described in conjunction with the following drawing figures, wherein like numerals denote like elements, and wherein:

FIG. 1 represents an isometric view of the thermostable system 100

FIG. 2 depicts the thermostable system 100 in a closed state

FIG. 3 depicts the thermostable system 100 in an open state

FIG. 4 is an isometric view of the front side of the stand 202

FIG. 5 is an isometric view of the back side of the stand 202

FIG. 6 is a section view of the container-lid 102

FIG. 7 is a section view of the container-base 106

FIG. 8 is an isometric view of the heater assembly

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

As used herein, the term PCM is used to refer to a phase change material prepared by mixing glutaric acid and catechol in a ratio of 4:1 and PCM Pouch refers to a Crafted Polypropylene Pouch (CPP) containing the above-mentioned PCM.

The terms “Insulation container” or “Hot Box” have been used interchangeably throughout the description.

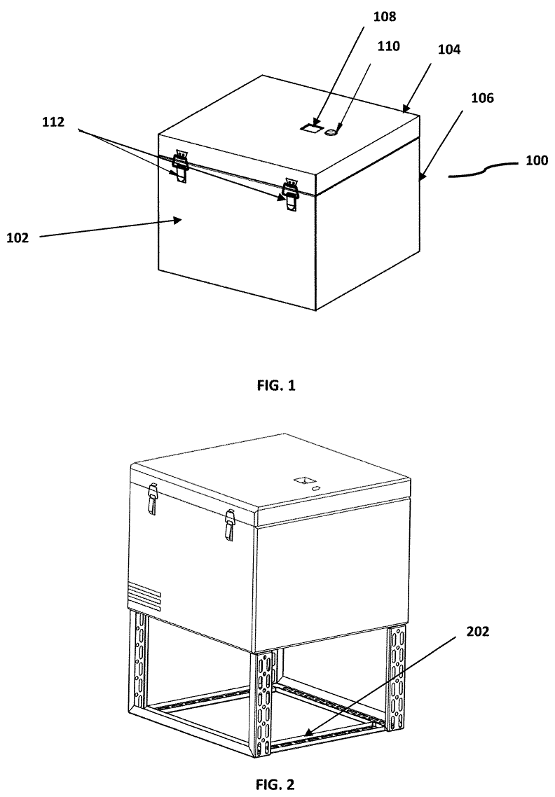

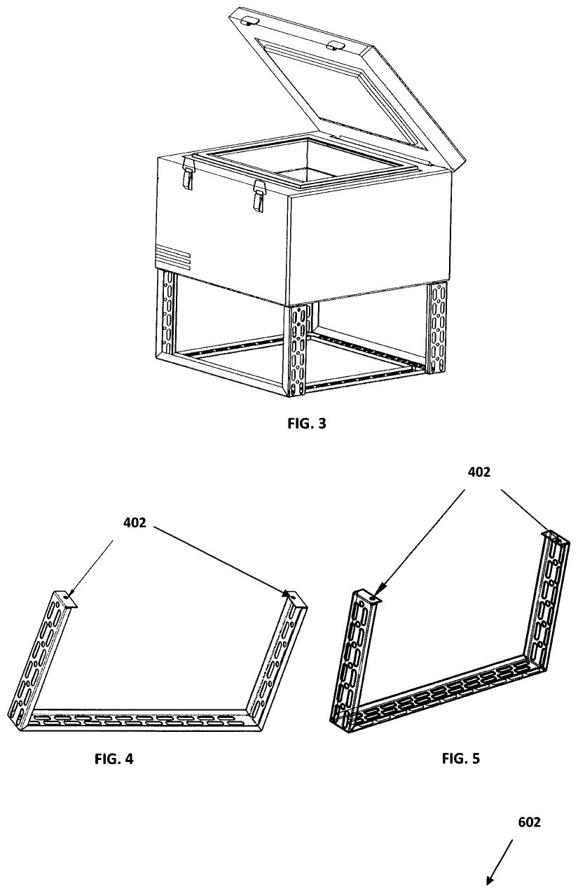

Referring now to FIGS. 1-5, FIG. 1 in an exemplary embodiment represents a thermostable system 100 proposed by the present invention. The thermostable system 100 broadly comprises an insulation container 102 and PCM Pouches.

The insulation container 102 has a top lid 104 attached to the bottom part of it—container-base 106. The lid 104 is fastened to the backside of the container-base 106 by means of hinges and is provided with latches 112 on the front side for opening and closing purposes. The latches 106 are made preferably of steel and contain springs to offer better locking and sturdiness. The hinges are provided on the outer side of the container 102 to have a smooth opening-closure. Placement of hinges on inner side of box leads to hard opening-closure of the lid. The lid 104 is equipped with a sensor display screen 108 on its upper surface along with a button 110. In an embodiment, the display screen 108 is a one square inch LCD screen and the button 110 is a push button.

In a preferred embodiment, a stand 202 is provided. The stand 202 offers convenient handling of the Hot Box and minimizes the chances of spillage or leakage of the contained goods by keeping the box in an upright position. FIG. 4 and FIG. 5 represent isometric views of the front side and of the back side of the stand 202 respectively. In a non-limiting example, the stand 202 was designed with 0.8 mm thickness GI metal sheets and mechanically affixed to the container-base 106 by means of bolts running through the bolting holes 402.

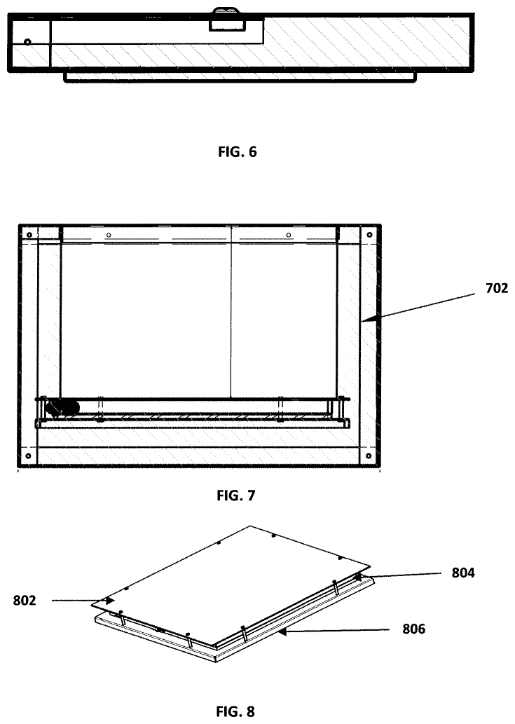

Referring now to FIG. 6 and FIG. 7. FIG. 6 is a section view of the lid 104 and FIG. 7 is a section view of the container-base 106. In the preferred embodiment, the insulation container 102 is designed to have an outer wall and an inner wall made up of 0.8 mm thick Aluminium. To provide insulation, Polyurethane Foam (PUF) is injected between the outer and inner walls of the container 102 through injection holes cut out in the container walls. Reference numerals 602 and 702 represent the PUF injected area in the lid 104 and in the container-base 106 respectively.

The insulation container 102 is further equipped with a heating assembly 800 as shown in FIG. 8. The heating assembly 800 broadly comprises a top plate 802, a bottom plate 806 and a tray 804 contained between the top and bottom plates. The heating assembly 800 is designed for uniform heating of goods placed inside a closed and sealed insulation container 102. The heating element of the said heating assembly is made up of Nichrome. The shape and size of the heating element can be customized based on the shape and size of the insulation container 102. In the preferred embodiment, the heating assembly 800 is designed to have a maximum surface temperature of 95° C. and is equipped with a circuit breaker to cut off power to the heater if the electrical current exceeds a certain limit. A microcontroller is also integrated with the heating assembly to regulate the heating of the assembly.

In an exemplary embodiment, the insulation container 102 is covered with Rexine cloth to enhance the aesthetics and facilitate convenient handling of the container. The Rexine cloth is glued to the aluminium container using 3M Glue.

The technical advantage of the invention is presented in the form of experimental results as given below:

The present invention preferably uses Polyurethane Foam (PUF) as the insulation material for the thermostable system 100.

The temperature monitoring of the insulation container being displayed on the sensor display 108 showed reduced risk of food contamination as compared to sensors which monitored the temperature of food products. This is because measurement of food temperature needs contact of sensor and food which may lead to unhygienic process as well as challenges in placement of sensor on food. The arrangement of the components of the present invention overcame this drawback.

By using the combination of PUF injected insulation container with PCM pouches, temperature range of 45-70° C. and holding time of 10-14 hours was achieved. Various thicknesses of the container and concentrations of the PCM solution were tested to achieve varying temperature ranges and holding times.

In one non-limiting example of the invention, a thickness of 12 mm of insulation container 102 was tested. The dimensions (Length×Width×height in centimetres) of the insulation container 102 were set to 20×15×12 for 12 mm thickness.

In another non-limiting example of the invention, a thickness of 20 mm of insulation container was tested. The dimensions (Length×Width×height in centimetres) of the insulation container 102 were set to 18×18×18 for 20 mm thickness.

The results achieved with the tested thicknesses are as follows:

TABLE 1
Technical specifications of 12- and 20-mm insulation containers

| | | 12 mm PU | | 20 mm PU | |
|---|---|---|---|---|---|
| SN | Technical specification | container | | container | |
| 1 | Heat transfer rate (For 3 days) | 378.00 | kJ/10 hr | 197.60 | kJ |
| 2 | Surface area | 0.1440 | m² | 0.1996 | m² |
| 3 | Temperature range | 45-70° | C. | 45-70° | C. |
| 4 | Holding capacity | 10 ± 2 | hrs | 14 ± 2 | hrs |

Using the thermostable system 100, as set forth by the present invention, with food products, it was observed that the food products remained intact in their quality, without a loss of aroma, taste, or texture.

The manufacturing costs of the containers used in present invention were observed to be lower than the other commercially available containers.

The most efficient form of the invention was observed with polyurethane foam being injected into the walls of the insulation container as compared to other the containers available in the market which are made using polystyrene, polyethylene, polyvinyl chloride, polypropylene, or polyethylene terephthalate.

The insulating material of the container was found to be light weight and easily biodegradable which made it convenient for storage, transport, and disposal after use.

The best results for storage in the desired temperature range were observed when the PCM was prepared suing glutaric acid and catechol in 4:1 ratio.

While at least one exemplary embodiment has been presented in the foregoing detailed description, it should be appreciated that a vast number of variations exist. It should be understood that various changes can be made in the function and arrangement of elements without departing from the scope of the invention as set forth in the appended claims and the legal equivalents thereof.

1. A thermostable system comprising:
an insulation container for storage or shipment of hot goods, wherein the insulation material used for preparation of the insulation container is Polyurethane Foam (PUF);
one or more crafted polypropylene pouches containing a Phase Change Material to maintain hot temperature inside the insulation container, wherein the phase change material is a mixture of glutaric acid and catechol; and
a heating assembly mechanically configured with the insulation container to provide uniform heating of the goods contained inside the insulation container.

2. A thermostable system according to claim 1, wherein a temperature range of 45-70° C. is maintained inside the insulation container for a period of 10-14 hours.

3. A thermostable system according to claim 1, wherein the Phase Change Material is prepared by mixing Glutaric Acid and Catechol in a ratio of 4:1.

4. A thermostable system according to claim 1, wherein the top lid of the insulation container is fastened to the container-base by means of a plurality of hinges and wherein said lid can be opened or closed using one or more latches provided on the front sides of said lid and of the container-base.

5. A thermostable system according to claim 1, wherein the insulation container is designed with 12 mm thickness of insulation material PUF and has a heat transfer rate of 378 Kj.

6. A thermostable system according to claim 1, wherein the insulation container is designed with 20 mm thickness of insulation material PUF and has a heat transfer rate of 197.60 kJ.

7. A method for storing or transporting a hot product, comprising utilizing the thermostable system according to claim 1 wherein the product comprises a food item.

8. A method for preparing a phase-change-material pouch comprising the steps of:
melting one part of Catechol in four parts of Glutaric Acid in a beaker at 110° C.;
mixing thoroughly;
cooling the mixture to let it crystallize;
melting the crystallized mixture at 80° C.; and
heat-sealing the melted crystallized mixture in Crafted Polypropylene Pouches (CPP).
